(19) United States
(12) Patent Application Publication
(10) Pub. No.: US 2026/0222829 A1
(43) Pub. Date: Jul. 30, 2026

(54) UPDATING A MACHINE LEARNING MODEL BASED ON INDICATED PARAMETERS

(71) Applicant: Lenovo (United States) Inc., Morrisville, NC (US)

(72) Inventors: Venkata Srinivas Kothapalli, Aurora, IL (US); Junghoon Kim, Chicago, IL (US)

(73) Assignee: Lenovo (United States) Inc., Morrisville, NC (US)

(21) Appl. No.: 19/039,216

(22) Filed: Jan. 28, 2025

(51) Int. Cl. H04W 24/02; H04L 41/16

(52) U.S. Cl. CPC H04W 24/02; H04L 41/16

(57) ABSTRACT

Various aspects of the present disclosure relate to updating a machine learning model based on indicated parameters. A network equipment (NE) may determine a subset of parameters of a set of parameters of a machine learning model based on a set of data samples, where the set of data samples includes a set of input data samples and a set of corresponding expected output data samples. The NE may transmit signaling to a user equipment (UE) that indicates the subset of parameters of the machine learning model. The UE updates the machine learning model by updating respective parameters of the subset of parameters and refraining from updating a remaining subset of the machine learning model. The UE and the NE then communicate based on updating the machine learning model.

### TECHNICAL FIELD

The present disclosure relates to wireless communications, and more specifically to machine learning in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. That is, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive signaling that indicates a subset of parameters of a set of parameters associated with a machine learning model, update the machine learning model by updating respective parameters of the subset of parameters and refraining from updating a remaining subset of the set of parameters associated with the machine learning model, and communicate based on updating the machine learning model.

A processor (e.g., a standalone processor chipset, or a component of a UE) for wireless communication is described. The processor may be configured to, capable of, or operable to perform one or more operations as described herein. For example, the processor may be configured to, capable of, or operable to receive signaling that indicates a subset of parameters of a set of parameters associated with a machine learning model, update the machine learning model by updating respective parameters of the subset of parameters and refraining from updating a remaining subset of the set of parameters associated with the machine learning model, and communicate based on updating the machine learning model.

A method performed or performable by a UE for wireless communication is described. The method may include receiving signaling that indicates a subset of parameters of a set of parameters associated with a machine learning model, updating the machine learning model by updating respective parameters of the subset of parameters and refraining from updating a remaining subset of the set of parameters associated with the machine learning model, and communicating based on updating the machine learning model.

In some implementations of the UE, the processor, and the method described herein, the UE, the processor, and the method may further be configured to, capable of, or operable to obtain a set of data samples, where the set of data samples includes a set of input data samples and a set of corresponding expected output data samples, and select one or more new values for the respective parameters of the subset of parameters based on the set of data samples and a loss function associated with the subset of parameters of the set of parameters. In some implementations of the UE, the processor, and the method described herein, the UE, the processor, and the method may further be configured to, capable of, or operable to receive, prior to the communicating, additional signaling including the set of data samples. In some implementations of the UE, the processor, and the method described herein, the UE, the processor, and the method may further be configured to, capable of, or operable to receive, prior to the communicating, additional signaling including one or more reference signals, and obtain, based on one or more measurements associated with the one or more reference signals, the set of data samples. In some implementations of the UE, the processor, and the method described herein, the UE, the processor, and the method may further be configured to, capable of, or operable to determine to update the machine learning model based on one or more changes in characteristics of the set of data samples. In some implementations of the UE, the processor, and the method described herein, the UE, the processor, and the method may further be configured to, capable of, or operable to receive additional signaling that indicates a periodicity associated with updating the machine learning model and determine to update the machine learning model based on the periodicity.

In some implementations of the UE, the processor, and the method described herein, the UE, the processor, and the method may further be configured to, capable of, or operable to receive additional signaling that indicates for the UE to update the machine learning model, where one or more of the signaling or the additional signaling are received from a first NE or a second NE, and determine, responsive to the additional signaling, to update the machine learning model. In some implementations of the UE, the processor, and the method described herein, the UE, the processor, and the method may further be configured to, capable of, or operable to determine to update the machine learning model based on one or more changes in network conditions associated with the communicating. In some implementations of the UE, the processor, and the method described herein, the UE, the processor, and the method may further be configured to, capable of, or operable to determine to update the machine learning model based on a quality associated with output from the machine learning model satisfying a threshold value. In some implementations of the UE, the processor, and the method described herein, the signaling includes the set of parameters and respective bit values corresponding to the subset of parameters, and where the respective bit values indicate the subset of parameters are associated with updating the machine learning model.

An NE (e.g., a base station) for wireless communication is described. The NE may be configured to, capable of, or operable to perform one or more operations as described herein. For example, the NE may be configured to, capable of, or operable to determine a subset of parameters of a set of parameters associated with a machine learning model based on a set of data samples, where the set of data samples includes a set of input data samples and a set of corresponding expected output data samples, transmit signaling that indicates the subset of parameters of the set of parameters, where the subset of parameters is associated with an update to the machine learning model, and communicate based on the update to the machine learning model.

A processor (e.g., a standalone processor chipset, or a component of a NE) for wireless communication is described. The processor may be configured to, capable of, or operable to perform one or more operations as described herein. For example, the processor may be configured to, capable of, or operable to determine a subset of parameters of a set of parameters associated with a machine learning model based on a set of data samples, where the set of data samples includes a set of input data samples and a set of corresponding expected output data samples, transmit signaling that indicates the subset of parameters of the set of parameters, where the subset of parameters is associated with an update to the machine learning model, and communicate based on the update to the machine learning model.

A method performed or performable by an NE (e.g., a base station) for wireless communication is described. The method may include determining a subset of parameters of a set of parameters associated with a machine learning model based on a set of data samples, where the set of data samples includes a set of input data samples and a set of corresponding expected output data samples, transmitting signaling that indicates the subset of parameters of the set of parameters, where the subset of parameters is associated with an update to the machine learning model, and communicating based on the update to the machine learning model.

In some implementations of the NE, the processor, and the method described herein, the NE, the processor, and the method may further be configured to, capable of, or operable to receive, prior to the signaling, additional signaling including the set of data samples. In some implementations of the NE, the processor, and the method described herein, the NE, the processor, and the method may further be configured to, capable of, or operable to receive, prior to the signaling, additional signaling including one or more reference signals, and obtain, based on one or more measurements associated with the one or more reference signals, the set of data samples. In some implementations of the NE, the processor, and the method described herein, the signaling includes the set of parameters and respective bit values corresponding to the subset of parameters, and where the respective bit values indicate the subset of parameters are associated with the update to the machine learning model. In some implementations of the NE, the processor, and the method described herein, to determine the subset of parameters, the NE, the processor, and the method may further be configured to, capable of, or operable to determine, during training of the machine learning model based on the set of data samples, respective sensitivity values corresponding to the set of parameters, and where the respective sensitivity values of the subset of parameters satisfy a threshold value. In some implementations of the NE, the processor, and the method described herein, to determine the respective sensitivity values corresponding to the set of parameters, the NE, the processor, and the method may further be configured to, capable of, or operable to compute, for respective parameters of the set of parameters, a set of gradient values corresponding to respective data samples of the set of data samples, and compute, for the respective parameters of the set of parameters, a set of absolute values for respective gradient values of the set of gradient values, where the respective sensitivity values include an average value of the set of absolute values for the respective parameters of the set of parameters.

In some implementations of the NE, the processor, and the method described herein, the NE, the processor, and the method may further be configured to, capable of, or operable to transmit, prior to the communicating, additional signaling including an additional set of data samples. In some implementations of the NE, the processor, and the method described herein, the NE, the processor, and the method may further be configured to, capable of, or operable to transmit, prior to the communicating, additional signaling including one or more reference signals, where the one or more reference signals are associated with an additional set of data samples. In some implementations of the NE, the processor, and the method described herein, the NE, the processor, and the method may further be configured to, capable of, or operable to transmit additional signaling that indicates a periodicity associated with the update to the machine learning model. In some implementations of the NE, the processor, and the method described herein, the NE, the processor, and the method may further be configured to, capable of, or operable to transmit additional signaling that indicates for a UE to update the machine learning model.

### BRIEF DESCRIPTION OF THE DRAWINGS

FIGS. 1 and 2 illustrate examples of wireless communications systems in accordance with aspects of the present disclosure.

FIGS. 3 and 4 illustrate example signaling diagrams, in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

A wireless communications system may include one or more devices, such as UEs and NEs, that transmit and receive signaling. The devices in the wireless communications system may implement one or more machine learning models for transmitting and/or receiving the signaling, such as to perform beam selection and management, perform channel state information (CSI) compression and reconstruction, to encode and/or decode data or control signaling, among other example use cases. The machine learning models may include one or more parameters (e.g., weights and/or biases) that are set to defined values during a training process. For example, in supervised training, a device may provide input to a machine learning model, may compare an output of the machine learning model to one or more expected (e.g., known, labeled) output values using a loss function, and may adjust the parameters of the machine learning model, accordingly. The loss function is a mathematical function that quantifies the difference between the output of the machine learning model and the expected output. In some examples, the devices may implement a trained machine learning model to transmit and/or receive the signaling. However, the input to the machine learning model may vary (e.g., due to network conditions, among other examples), leading to inaccurate or incorrect output from the machine learning models. Thus, the devices may adapt the machine learning models by updating the parameters to new values to account for the variations in the input values. In some instances, the machine learning model may have a significant numerical quantity of parameters (e.g., thousands or more parameters), which may lead to high signaling overhead and increased usage of computational resources to update an entire machine learning model.

As described herein, instead of updating all of the parameters of a machine learning model, one or more devices (e.g., a NE and/or a UE) may update a subset of parameters of the machine learning model. In some examples, different parameters of a machine learning model may have different levels of influence (e.g., impact, importance, control) over the output of the machine learning model. For example, a first parameter of the machine learning model may have a relatively low level of influence over the output of the machine learning model, such that a change to the value of the first parameter may not materially impact the output of the machine learning model (e.g., the change to the output may be within a threshold difference relative to prior to the change to the value of the first parameter). In some other examples, a second parameter of the machine learning model may have a relatively high level of influence over the output of the machine learning model, such that a change to the value of the second parameter may materially impact the output of the machine learning model (e.g., the change to the output may be outside of the threshold difference relative to prior to the change to the value of the second parameter). Such level of influence may be quantified as a sensitivity value in machine learning models. Thus, a device may determine respective sensitivity values for the parameters of the machine learning model that are numerical representations of the level of influence over the output of the machine learning model for each parameter. If the sensitivity value for a parameter satisfies (e.g., exceeds, is greater than) a threshold value, then the device may indicate to one or more other devices that the parameter is to be updated when the devices update the machine learning model. The devices may update the indicated parameters of the machine learning model and may not update (e.g., refrain from updating) the other parameters of the machine learning model to adapt the machine learning model to variations in input values without excessive use of processing, memory, and power resources.

By performing the described techniques, a device in a wireless communications system can update a portion (e.g., subset) of parameters of a machine learning model rather than updating an entirety of the parameters of a machine learning model to account for variations in input values to the machine learning model. Updating a portion of the parameters of the machine learning model reduces the use of computational resources at the device updating the machine learning model, including memory, processing, and power consumption resources at the device. Further, updating a portion of the parameters of the machine learning model reduces latency related to updating an entirety of the parameters of a machine learning model, as the device updates fewer than the total number of parameters of the machine learning model.

Reference is made herein to communicating data or information, such as signaling data samples, reference signals, configuration information, and/or parameters of machine learning models, among other examples, that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

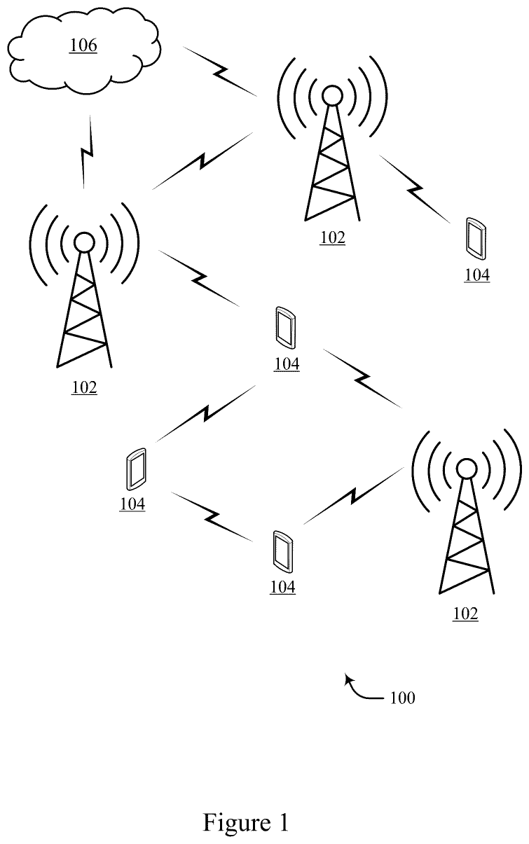

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some examples, one or more devices in the wireless communications system 100 (e.g., a UE 104 and/or a NE 102) may implement machine learning or artificial intelligence to communicate. For example, the devices may implement one or more machine learning models, which may also be referred to as artificial intelligence models, neural networks, learning models, or algorithms, among other examples. A machine learning model may include an algorithm with learnable parameters (e.g., a support vector machine or a decision tree) or a neural network with neuron weights as learnable parameters. The machine learning model may be an example of any type of algorithm or neural network, such as a deep neural network (DNN). The devices may implement the machine learning models at a transmit-receive chain to encode, transmit, decode, receive, and/or make one or more inferences or predictions related to signaling (e.g., data or control signaling). For example, the devices may use the machine learning models for CSI compression, beam prediction, and positioning.

In some examples, a device (e.g., the UE 104 and/or the NE 102) can implement one or more learning models for beam prediction. For example, the device can train a learning model to output a prediction of a transmit and/or receive beam to use for reliable transmission or reception of signaling. The device can input one or more beam measurements to the learning model to obtain the prediction of the transmit and/or receive beam. Example beam measurements include, but are not limited to, beamforming gain measurements, beamwidth measurements, reference signal received power (RSRP) measurements, and signal-to-interference plus noise ratio (SINR) measurements, among other measurements. The beam prediction can include spatial beam prediction, in which the device implements the learning model to determine a beam of a set of available or candidate beams in a wireless network using a relatively small numerical quantity (e.g., less than a threshold numerical quantity) of beam measurements. For example, the numerical quantity of beam measurements can be less than a numerical quantity of available or candidate beams. Additionally, or alternatively, the beam prediction can include temporal beam prediction, in which the device implements the learning model to determine a beam to use for transmission during one or more subsequent time slots using a relatively small numerical quantity (e.g., less than a threshold numerical quantity) of historical beam measurements or identifiers of beams that are historically selected for transmitting and/or receiving signaling.

In some variations, the device implements the learning model to predicting information. For example, the device implements the learning model to estimate CSI across a space-time grid based on pilot and/or reference signals sent over a relatively small numerical quantity (e.g., less than a threshold numerical quantity) of resource elements in the space-time grid. The device implements the learning model to perform CSI prediction, such that the learning model outputs a prediction of CSI (e.g., a channel quality indicator (CQI), a precoding matrix indicator (PMI), a rank indicator (RI), or a modulation and coding scheme (MCS) index) for one or more future time slots based on the estimated CSI and/or additional information for one or more previous time slots. Additionally, or alternatively, the UE 104 and/or the NE 102 implements the learning model to function as a receiver. For example, the learning model outputs a prediction of a transmitted message, symbol, or bit based on one or more signals received as output from a wireless channel. In some examples, the device can implement one or more learning models for positioning procedures. For example, the device implements the learning model to determining a position of a node (e.g., a UE 104, a NE 102, or any other device in the wireless communications system 100) based on a channel impulse response (CIR) experienced by the node. A CIR defines how a signal propagates through the channel over time.

A device can train the learning models using a training dataset obtained either through simulations or through measurements (e.g., considering either one or, at most, a finite set of physical cell-sites, network configurations, and/or channel characteristics). When a dataset includes both an input data sample and a corresponding output data sample for data samples in the dataset, the dataset is referred to as a labeled dataset and the data samples are referred to as labeled data samples. When the dataset includes the input data sample without the corresponding output data sample, the dataset is referred to as an unlabeled dataset and the data samples are referred to as unlabeled data samples. In some examples, a device can implement supervised learning techniques to train the learning models. For example, the device can train the learning models to map input data to output labels based on example input-output pairs provided during training. In supervised learning, the learning model computes a mapping function from input features to output labels by observing a dataset that includes labeled examples, such that the learning models can generalize the mapping to make accurate predictions on new, unseen data. Although supervised learning techniques are described, the device can additionally, or alternatively, implement any other type of training techniques to train the learning models, including, but not limited to, unsupervised learning techniques and semi-supervised learning techniques, among others. In unsupervised learning, the learning models detects patterns, structures, or relationships within training data. Unlike supervised learning, there are no explicit output labels provided during training. Semi-supervised learning leverages both labeled and unlabeled data during a training procedure. The learning models use the labeled examples, while also using the structure of the unlabeled data to improve a performance of the learning models.

In some examples xᵢ∈ [symbol] and yᵢ∈ [symbol] denote an input sample and a corresponding label or desired output data sample from a learning model for an input xᵢ. In some variations, yᵢ is referred to as a prediction and/or inference for input xᵢ. In some cases, xᵢ is a scalar or a one or multi-dimensional vector and yᵢ is a scalar or a one or multi-dimensional vector. [symbol] and [symbol] denote the input sample space and the output sample space (e.g., label space), respectively. A learning model defines a mapping or a function, f_{W}, where f_{W}: [symbol] → [symbol] . Here, W∈ [symbol] denotes a set of learning model parameters that are learned during the process of training the learning model. Example learning model parameters include, but are not limited to, weights, biases, and activation function parameters, among other parameters. Weight parameters represent a strength of connections between neurons in different layers of the learning model. Biases are additional parameters added to neurons in the learning model that provide for the learning model to capture offset or bias in input data. Activation function parameters can include slope parameters or parameters defining a shape of an activation function in a parametric activation function. Determining one or more values of model parameters for a defined use case is referred to as training the model or learning the model. The general procedure of developing a learning model includes updating one or more parameters to minimize a loss function based on a training dataset that includes either labeled samples or unlabeled samples, resulting in supervised learning or training or unsupervised learning or training, respectively.

In some examples, a device can implement or deploy a trained learning model, such as to make predictions or inferences. The learning model can be expected to perform with a same level of accuracy and/or precision by providing desired inferences or predictions as seen during the training and testing phase of the learning models before deployment. However, in a real-world wireless network (e.g., in the wireless communications system 100), a learning model can make predictions or inferences using input data that has different statistical characteristics than the dataset over which the learning model is trained. A learning model that uses input data with different statistical characteristics than the dataset over which the learning model is trained can output erroneous (e.g., incorrect) inferences or predictions. To improve accuracy of the inferences and/or the predictions, a device can train a learning model with a generalized ability to make inferences and/or predictions over many different data distributions (e.g., data distributions that are different from training data distributions and encountered at a time of inference). However, developing a learning model that generalizes the possible domains and outputs a desired performance across the domains may be difficult for the device, especially in the context of wireless networks with varying statistics of data distributions.

A device may train a machine learning model on a set of data samples,

$${𝒟}^{s} = {\{ ( {x}_{i}^{s} , {y}_{i}^{s} ) \}}_{i = 1}^{n}$$

distributed according to a statistical distribution,

$$∼ {P}_{XY}^{k} ,$$

where the set or data samples may be referred to as a source domain or a source data domain. The term domain implies data with a defined distribution. A source domain is a domain over which the learning model is trained, where xs∈ [symbol] and ys∈ [symbol] , and the joint prohability density function

$${P}_{XY}^{s} : 𝒳 \times 𝒴 \to {ℝ}^{+}$$

denotes the source distribution. The device may train the machine learning model on more than one source domains or over a data set that includes data samples coming from more than one source domains, resulting in multiple source domains,

$${𝒟}^{{s}_{i}} = {\{ ( {x}_{i}^{{s}_{i}} , {y}_{i}^{{s}_{i}} ) \}}_{i = 1}^{{N}_{tr}} ∼ {P}_{XY}^{{s}_{i}} , i = 1 , … , \hat{S} ,$$

where Ŝ is a number (e.g., amount, numerical quantity) of source domains.

A target domain is a domain over which the learning model is executed to provide inferences and/or predictions. In some examples, there can be different target domains for different network conditions, device parameters, channel characteristics, or any other factor that impacts the data distribution (e.g., variation) of one or more data samples. Thus, when a device implements or uses a machine learning model to make inferences on input data samples,

$${x}_{i}^{t} ,$$

to predict a corresponding label,

$${y}_{i}^{t} , where {𝒟}^{t} = {\{ ( {x}_{i}^{t} , {y}_{i}^{t} ) \}}_{i = 1}^{N} ∼ {P}_{XY}^{t} , {𝒟}^{t}$$

is the target domain and the probability density function

$${P}_{XY}^{t} : 𝒳 \times 𝒴 \to {ℝ}^{+}$$

is referred to as a target distribution. A device can store the machine learning models and/or can transmit an indication of the machine learning models to another device for storage. At any instant in time, the device and/or the other device can select and execute one of the models for making inferences and/or predictions.

In some examples, a device may train a machine learning model using a source domain having the distribution

$${P}_{XY}^{s} : 𝒳 \times 𝒴 \to {ℝ}^{+} .$$

Once deployed to a device, the device may implement the machine learning model on a target domain with a joint probability density function,

$${P}_{XY}^{t} : 𝒳 \times 𝒴 \to {ℝ}^{+}$$

The target distribution may be different than the source distribution

$${P}_{XY}^{t} \neq {P}_{XY}^{s} . As {P}^{s} ( x , y ) = {P}^{s} ( x ) {P}^{s} ( y \vert x ) and {P}^{t} ( x , y ) = {P}^{t} ( x ) {P}^{t} ( y \vert x ) , {P}_{XY}^{t} \neq {P}_{XY}^{s}$$

implies that either, P^{s}(x)≠P^{t}(x) and P^{s}(y|x)=P^{t}(y|x) or, P^{s}(x)=P^{t}(x) and P^{s}(y|x)≠P^{t}(y|x) or, P^{s}(x)≠P^{t}(x) and P^{s}(y|x)≠P^{t}(y|x). Thus, the device may provide data samples as input to the machine learning model during implementation with new (e.g., different) data distributions when the input distribution P(x) changes, the label distribution P(y) changes, or the conditional distribution P(y|x) changes. Thus, outputs from the machine learning model, f_{W}, learned or trained over source domain data samples having a joint probability density function,

$${P}_{XY}^{s} ,$$

may not be accurate for input data samples from a target domain having a different distribution and probability density function,

$${P}_{XY}^{t} .$$

In some cases, a NE 102 (e.g., a gNB) in the wireless communications system 100 may implement multiple antennas, such as nₜ antennas (e.g., in the form of one or more antenna array panels). One or more UEs 104, such as K UEs 104, may each have one or more antenna array panels with multiple antenna elements in each panel. The wireless communications system 100 may support communication over millimeter wave (mmWave) frequencies in FR2. In the mmWave frequency range, the devices in the wireless communications system 100 may communicate through narrow beams formed using multiple antenna elements available at the NE 102 and the UEs 104 (e.g., to overcome a propagation loss at the mmWave frequencies and to maintain sufficient signal strength). A total number of beams formed by the NE 102 (e.g., across all antenna panels at the NE 102) is M and each UE 104 forms N number of beams. The beams are directional in nature (e.g., providing directional gain) and may have a narrow beam width (e.g., less than a threshold beam width). A NE 102 and a UE 104 may select respective beams for achieving a reliable communication link between the NE 102 and a UE 104, which is referred to as beam search or beam selection. That is, for enabling communication between the NE 102 and the UE 104, the NE 102 and/or the UE 104 may select a beam-pair (e.g., a beam at the NE 102 and a beam at the UE 104) that results in a signal strength at the receiver being satisfied. In a downlink direction for signaling from the NE 102 to the UE 104, beam selection corresponds to selecting a transmit beam at the NE 102 and a corresponding receive beam at the UE 104. Additionally, or alternatively, in an uplink direction for signaling to the NE 102 from the UE 104, beam selection corresponds to selecting a transmit beam at the UE 104 and a corresponding receive beam at the NE 102.

A device (e.g., the UE 104 and/or the NE 102) may search over all possible beams and select a beam that results in a maximum signal strength, which is referred to as an exhaustive search method for beam selection. For downlink communication, a NE 102 may send a reference signal on all possible transmit beams to a UE 104. The UE measure the received signal strength (e.g., Layer 1 (L1) RSRP and SINR) on the beams and determines a beam providing a highest received signal strength. The UE 104 reports an indication of the beam (e.g., a beam index for the beam) to the NE 102 for selecting a transmit beam at the NE 102 for a given receive beam at the UE 104. The UE 104 may determine a receive beam for the downlink communication by fixing the selected transmit beam at the NE 102 and measuring received signal strength from each receive beam. Such exhaustive search would result in selecting a beam with a highest received signal strength (e.g., an optimal beam), but increases latency and signaling overhead at the UE 104 and at the NE 102 due to the transmission and measurement of reference signals via each beam.

Thus, one or more devices in the wireless communications system 100 (e.g., the NE 102 and/or a UE 104) may implement machine learning models to perform beam selection, which may also be referred to as beam prediction. For example, the devices may select a beam out of M beams, where a value of M may range from 8 to 256 or higher. The beams may span over an angular space with each beam directed towards a different azimuth and/or elevation angle. Additionally, or alternatively, a footprint of the beams may span a one-dimensional space or a two-dimensional space. For exhaustive beam selection, a device may perform M beam measurements. In some cases, a device may perform supervised learning to train a machine learning model (e.g., a neural network, a DNN) using labeled training data, such that the machine learning model determines a beam with a highest signal strength (e.g., an optimal beam) based on an input. The input may include a subset of beam measurements, M′ beam measurements, where M′<M. The beams for which the device is to measure are selected and fixed prior to the device performing the beam measurements. The training data includes labeled samples Z₁, . . . , Z_{N}_{ₜᵣ}, Nₜᵣ>>1, where i^{th} sample of the training data set can be expressed as

$$( ( {S}_{0}^{i} , {S}_{1}^{i} , … , {S}_{{M}^{′} - 1}^{i} ) , {B}_{i} ) ,$$

where Sᵢ denotes the signal strength (e.g., RSRP and/or SINR) over the i^{th} beam and Bᵢ is the beam index with a highest signal strength corresponding to the beam measurements

$$( {S}_{0}^{i} , {S}_{1}^{i} , … , {S}_{{M}^{′} - 1}^{i} ) .$$

Thus, a device trains a machine learning model to determine a mapping between the beam measurements (S₀, S₁, . . . , S_{M′-1}) and a beam index, B, of a beam with the highest signal strength. When deployed at a device, the device may provide M′ beam measurements as input to the machine learning model, and the machine learning model may determine or output a beam index for a beam resulting in a highest signal strength (e.g., an optimal beam index).

A device may implement machine learning models for beam selection for one or more defined cell sites, for a network configuration, for a channel type, or for one or more antenna parameters for which the machine learning model is trained, among other examples. Implementing machine learning models for beam selection reduces latency and signaling overhead, as the machine learning model computes a beam to use for communications using relatively few beam measurements when compared with the exhaustive beam search approach. In some examples, P(x) for a machine learning model developed for beam selection, referred to as a beam selection machine learning model, is a joint marginal density of the beam measurements (S₀, S₁, . . . , S_{M′-1}) supplied as input to the beam selection machine learning model. The P(x) may change from one geographic location to another or from one cell site to another due to a change in the physical channel characteristics between the two geographic locations or cell sites. Further, measurement noise may impact the values of the beam measurements, which may result from thermal noise, hardware imperfections of related modules in the transmit chain, or differences in the hardware and the corresponding measurement sensitivity across different user devices, among other examples. Thus, the distribution of beam measurements (S₀, S₁, . . . , S_{M′-1}), which is the distribution P(x) of the input samples to the beam selection machine learning model, is vulnerable to variations. The relation or mapping between the beam measurements and a corresponding beam with a highest signal strength may change depending on the physical characteristics of the propagation medium. For example, the mapping between beam measurements and a beam with a highest signal strength changes from outdoor scenarios to indoor scenarios. Thus, P(y|x), the distribution of output conditioned on input, may change for beam selection.

A device in the wireless communications system 100 (e.g., a UE 104 and/or a NE 102) may adapt an already trained machine learning model (e.g., a DNN) to previously unseen target domains. For example, the device may use labeled data samples and/or unlabeled data samples from one or more new target domains to update one or more parameters of the machine learning model. The device may update or adapt any type of machine learning model, including machine learning models for regression or classification. Further, the device may implement supervised learning, unsupervised learning, or semi-supervised learning techniques to update or adapt the machine learning model, among other examples.

In some cases, a device (e.g., a NE 102 and/or a UE 104, or another network device) may train a machine learning model over one or more data sets. The data sets can include labeled data samples or unlabeled data samples, leading to supervised training or unsupervised (e.g., self-supervised training), respectively. The devices may develop machine learning models for wireless communications (e.g., beam management, CSI prediction and/or compression, or positioning) the by training and testing with data sets constructed either from simulated data and/or from the real-world data collected from functioning wireless networks. For example, the data samples

$${𝒟}_{tr}^{s} = {\{ ( {x}_{i}^{s} , {y}_{i}^{s} ) \}}_{i = 1}^{{N}_{tr}} ∼ {P}_{XY}^{s}$$

denote the set of labeled training data samples from source domain s, where

$${x}_{i}^{s} ∈ 𝒳 and {y}_{i}^{s} ∈ 𝒴$$

denote an input data sample and the corresponding labeled data samples or desired output data sample from a machine learning model for input xᵢ. A machine learning model may be represented as a mapping or a function, f_{W}, where f_{W}: [symbol] → [symbol] , where

$$W = {\{ {w}_{i} \}}_{i = 1}^{N}$$

denotes the set of model parameters. Determining the optimal values of model parameters (e.g., determining W) using the data set

$${𝒟}_{tr}^{s}$$

is referred to as training the model or learning the model. Supervised learning or training of a machine learning model includes minimizing a loss function, L. For example, a device may determine the set of parameters (e.g., W) by solving Equation 1.

$$W = {min}_{{W}^{′} ∈ {ℝ}^{N}} L ( {W}^{′} , {𝒟}_{tr} ) \qquad ( 1 )$$

The learned or trained machine learning model (e.g., the mapping), f_{W}, which may be a DNN, generates a probability distribution P(y|x; W) over the predictions y, conditioned on the input x and parameterized by W, and the conditional distribution is differentiable in W. If the task is classification, then an output space may include a finite numerical quantity of values. That is, a cardinality of the set [symbol] is finite for classification. Thus, [symbol] ={y⁽¹⁾, . . . , y^{(c)}}, where C is the number of possible values of a labeled data sample. In some cases, P(y^{(c)}|xᵢ; W) is the probability that y^{(c)} is the label, prediction, or class with c∈{1, . . . , C} for the given input xᵢ, as per the prediction or inference made by the machine learning model with W as the model parameters. Note that

$${\sum }_{c = 1}^{C} P ( {y}^{( c )} \vert {x}_{i} ; W ) = 1 ,$$

or, equivalent, [symbol] P(y^{(c)}|xᵢ; W)=1. If the expected output, the expected prediction, or the expected inference, yᵢ for an input xᵢ is a continuous valued real number (e.g., when yᵢ∈ [symbol] ), then the task being performed is referred to as regression, and the machine learning model is referred to as a regression model.

If a data set includes both input data samples and the corresponding output data samples (e.g., labels), then the data set is referred to as a labeled data set with labeled data samples. If a data set includes input data samples without the corresponding output data samples (e.g., labels), then the data set is referred to as an unlabeled data set with unlabeled data samples. The task of domain generalization is to learn a predictive function g: [symbol] →L to achieve a minimum prediction error on the data over source domains as well as the unseen target domain. The task of domain adaptation is the same as that of the domain generalization. For domain adaptation, a machine learning model has access to target domain data during training (e.g., one or more samples of labeled or unlabeled data from the target domain). In domain generalization, the machine learning model does not have access to target domain data during training, and the machine learning model is provided data samples from target domain at the time of inference and testing. A device may implement domain generalization and domain adaptation to provide for a machine learning model to generate accurate and precise output across multiple domains (e.g., over data having widely different statistical characteristics). Depending on a time period during which the generalization or adaptation of a machine learning model is applied, the generalization or adaptation can be classified as training-time adaptation, test/inference time-adaptation and training and test time adaptation.

In some examples, an entire machine learning model (e.g., all of the parameters of a machine learning model) is adapted for a target domain. That is, values of each parameter are updated to new values to account for variations in input data samples by training the machine learning model using data samples representative of the variations in the input data samples. For DNNs, domain adaptation and domain generalization methods involve multiple iterations of forward pass and backward propagation over the entire machine learning model, which leads to a device computing a gradient of a loss function with respect to each parameter of the machine learning model in each iteration. Once the training is done, the final parameters (e.g., optimal parameters) are determined for the target domain data. Many DNNs are relatively large and include a relatively large number of layers with each layer including a relatively large number of neurons or weights (e.g., have greater than a threshold numerical quantity of parameters). Adapting all the parameters of a machine learning model, such as a DNN, involves a large computational complexity and consumes a significant amount of time (e.g., greater than a threshold). However, the device may benefit from adapting a machine learning model in near-real time to avoid disruption to the functionality of the wireless network, which may not be possible while adapting all of the parameters of the machine learning model.

In some examples, a device in the wireless communications system may update a portion (e.g., a subset, a few) parameters of the machine learning model, which reduces the complexity and the time period for adapting the machine learning model when compared with techniques that involve adapting the entirety of the parameters of the machine learning model. Adapting a machine learning model (e.g., a DNN) may also be referred to as updating the machine learning model or modifying the machine learning model and may include replacing values of some or all of the parameters of the machine learning model with new values obtained from training the machine learning model with new data samples (e.g., for a different target domain than the machine learning model was originally trained with).

Reference is made herein to communicating data or information, such as signaling and/or communications that are transmitted or received between devices. It is to be appreciated that other terms may be used interchangeably with communicating, such as signaling, transmitting, receiving, outputting, forwarding, retrieving, obtaining, and so forth.

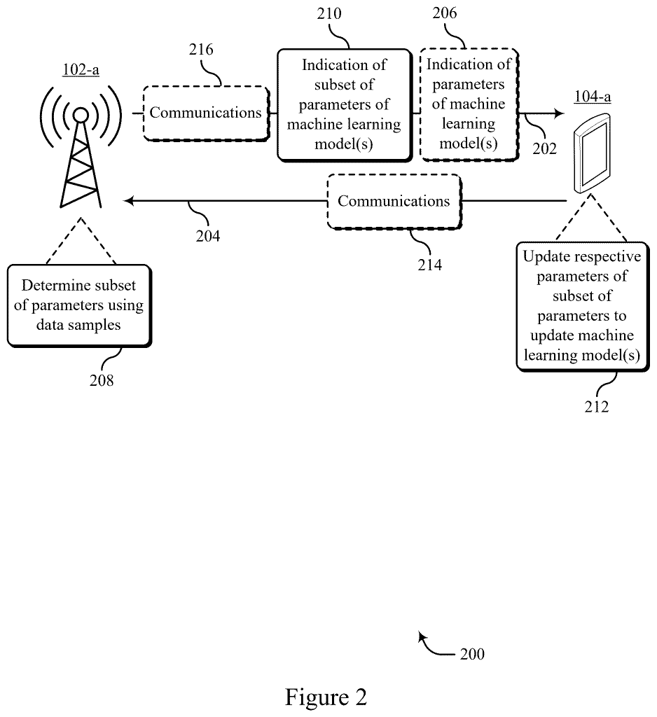

FIG. 2 illustrates an example of a wireless communications system 200 in accordance with aspects of the present disclosure. In some examples, the wireless communications system 200 implements aspects of the wireless communications system 100. For example, the wireless communications system 200 includes a NE 102-a and a UE 104-a, which may be examples of a NE 102 and a UE 104 as described with reference to FIG. 1. In some examples, the UE 104-a and the NE 102-a may exchange signaling with one another. For example, the NE 102-a may transmit signaling to the UE 104-a via a downlink communications link 202, which may be an example of a communications link as described with reference to FIG. 1. In some other examples, the UE 104-a may transmit signaling to the NE 102-a via an uplink communications link 204, which may be an example of a communications link as described with reference to FIG. 1. The signaling between the UE 104-a and the NE 102-a may include control signaling and/or data transmissions.

In some examples, the NE 102-a and/or the UE 104-a may implement one or more machine learning models. A machine learning models may refer to an algorithm or other computational structure designed to learn patterns and make predictions from data, such as for wireless communication tasks. A machine learning model may be an example of a neural network (e.g., a DNN), a decision tree, a support vector machine, and/or other algorithms capable of processing input data to generate desired outputs. The UE 104-a and/or the NE 102-a may implement one or more machine learning models for beam selection, CSI inference or compression, or positioning, among other example wireless communication tasks. For example, the UE 104-a and/or the NE 102-a may receive an indication of one or more machine learning models from a network node (e.g., device) or load the one or more machine learning models from local storage. The machine learning models may be initially trained on a large dataset in a controlled environment, such as by the NE 102-a or another third party device or node.

For example, the NE 102-a may train one or more machine learning models to obtain parameters of the machine learning models and may transmit the parameters to the UE 104-a in signaling (e.g., an indication of parameters of machine learning models 206). The NE 102-a may train the machine learning models by collecting labeled data samples (e.g., from another network node or by measuring reference signals) and by adjusting parameters of the machine learning model to minimize a loss function based on the labeled data samples, as described with reference to FIG. 1. The NE 102-a may periodically train machine learning models to obtain the parameters of the machine learning models and may transmit the indication of parameters of the machine learning models 206 to the UE 104-a after training the machine learning models. The NE 102-a may transmit the indication of parameters of the machine learning models 206 to the UE 104-a in control signaling, such as radio resource control (RRC) signaling, downlink control information (DCI), a medium access control-control element (MAC-CE), or any other type of control signaling. The UE 104-a and the NE 102-a may use the parameters to implement the machine learning models for the wireless communication tasks.

In some other examples, the NE 102-a and/or the UE 104-a may be hard coded, preconfigured, or may otherwise obtain one or more trained machine learning models. If the NE 102-a obtains the trained machine learning models, then the NE 102-a may transmit the indication of parameters of the machine learning models 206 to the UE 104-a without further training of the machine learning models. If the UE 104-a obtains the trained machine learning models (e.g., via hard coding or via a network node other than the NE 102-a), then the NE 102-a may not transmit the indication of parameters of the machine learning models 206 to the UE 104-a. The UE 104-a and the NE 102-a may use the parameters of the trained machine learning models for the wireless communication tasks.

For example, the UE 104-a and/or the NE 102-a may collect relevant input data samples. For beam selection, data samples may include channel measurements or reference signal information. For CSI compression, the data samples may include raw CSI measurements. For positioning, the data samples may include signal strength measurements, time of arrival data, or other location-related metrics. The UE 104-a and/or the NE 102-a may use the deployed machine learning models to process the input data and generate outputs. For beam selection, the output may include a prediction of one or more beam indices of beams with a highest signal strength (e.g., an optimal or best beam) for transmission and reception at the UE 104-a and the NE 102-a. For CSI compression, the output may include a compressed or decompressed CSI or may include a prediction of CSI. For positioning, the output may include estimated coordinates or location probabilities of the UE 104-a and/or the NE 102-a. The UE 104-a and/or the NE 102-a may update (e.g., adapt, modify) the machine learning models based on variations in data samples (e.g., a target domain) that cause a quality of the output to fall below a threshold quality, changing network conditions, or a periodicity, among other examples. Updating the machine learning models may include changing (e.g., updating, adapting, modifying) values of parameters of the machine learning models. The UE 104-a and/or the NE 102-a may continuously evaluate a performance of the machine learning models (e.g., a quality, accuracy, or precision of the output of the machine learning models) and may trigger updates to the machine learning models if the performance falls below a threshold value or if instructed by a configuration for updating the machine learning models. In some cases, the UE 104-a may transmit feedback to the NE 102-a including an indication of a performance of one or more machine learning models. The NE 102-a may use the feedback to determine whether to adapt or completely retrain a machine learning model or trigger updates across multiple devices (e.g., other UEs).

In some examples, not all parameters of a machine learning model are equally responsible in determining the output of the machine learning model. Some of the parameters (e.g., neural layers and corresponding neuron weights) may have a dominant role in determining the output of the machine learning model given an input data sample. That is, some of parameters or neurons are more sensitive (e.g., have a higher sensitivity) to the input data samples. The influence of the parameters on the machine learning model output is higher than that of the other parameters due to the increased sensitivity. In a trained machine learning model with parameters given by W=[w₁, . . . , w_{N}]^{T}∈ [symbol] ^{N}, the inference performance of the machine learning model is more sensitive to some of the parameters in w₁, . . . , w_{N} than other parameters. That is, a portion (e.g., subset, some) parameters of the machine learning model have a greater impact (e.g., influence, control) over the output of the machine learning model than other parameters. The parameters with greater than a threshold impact over the output of the machine learning model may be referred to as sensitive parameters or important parameters. For the sensitive parameters, if the value of the parameter changes by a small amount from the original trained value (e.g., by less than a threshold amount), then the overall performance of the machine learning model may change significantly (e.g., greater than a threshold impact to the performance of the machine learning model). For any remaining parameters (e.g., parameters that are not sensitive or have less than a threshold impact over the output of the machine learning model), the overall performance of the machine learning model does not change significantly if the values of the parameters change from the original trained value.

In some cases, at 208, the NE 102-a may determine a subset of parameters using one or more data samples (e.g., labeled data samples or unlabeled data samples). For example, the NE 102-a my determine the sensitive parameters (e.g., neurons) of a machine learning model during the training of the machine learning model using labeled data samples. A machine learning model, f_{W}, trained to perform one or more tasks on one or more data domains may have trained parameters (e.g., optimal parameters for the data domains)

$$W = {\{ {w}_{j} \}}_{j = 1}^{N} .$$

The trained parameters may also be denoted as a vector W=[w₁, . . . , w_{N}]^{T}. The sensitivity or the importance of a parameter wⱼ, 1≤j≤N, of the machine learning model, f_{W}, with

$$W = {\{ {w}_{j} \}}_{j = 1}^{N}$$

as the trained optimal may be determined according to Equation 2.

$${β}_{j} = \frac{1}{{N}_{tr}} {\sum }_{i = 1}^{{N}_{tr}} \vert \frac{\partial L ( W , {𝒟}_{tr}^{s} )}{\partial {w}_{j}} \vert = \frac{1}{{N}_{tr}} {\sum }_{i = 1}^{{N}_{tr}} \vert \frac{\partial L ( {f}_{W} ( {x}_{i}^{s} ) , {y}_{i}^{s} )}{\partial {w}_{j}} \vert \qquad ( 2 )$$

In some cases,

$$\frac{\partial L ( {f}_{W} ( {x}_{i}^{s} ) , {y}_{i}^{s} )}{\partial {w}_{j}}$$

is the gradient of the loss function with respect to wⱼ at input sample

$${x}_{i}^{s} , {𝒟}_{tr}^{s} = {\{ ( {x}_{i}^{s} , {y}_{i}^{s} ) \}}_{i = 1}^{{N}_{tr}} ∼ {P}_{XY}^{s}$$

denotes the set of labeled data samples from source domain s (e.g., where

$${x}_{i}^{s} ∈ 𝒳$$

and

$${y}_{i}^{s} {∈}^{t} 𝒴$$

denote an input sample and the corresponding label, respectively) used for training the machine learning model and |Z| denotes absolute value of Z. The value of βⱼ is a measure (e.g., an indication) of the sensitivity or importance of the parameter wⱼ. If the value of βⱼ is higher for a parameter wⱼ, then the parameter wⱼ may be a sensitive or important parameter.

In some cases, the parameters or weights of batch normalization layers of the machine learning model may be included in the subset of important or sensitive parameters of the machine learning model. A batch normalization layer in a machine learning model normalizes the input to each layer during training by adjusting and scaling the activations to maintain a consistent distribution of values. The batch normalization layers may adapt machine learning models to new data distributions by minimizing changes in input statistics across different domains or operating conditions. For example, the batch normalization layers adjust the data distribution and provide internal correction to a covariate shift of the data samples as the input data samples propagate through the machine learning model. Thus, changes to parameters of a batch normalization layer may lead to a substantial change in the performance of the machine learning model (e.g., greater than a threshold impact to the performance of the machine learning model).

Additionally, or alternatively, convolution layers of a machine learning model may include sensitive parameters relative to parameters of feedforward layers. Convolution layers may process input data samples by applying filters or kernels across the input data samples to capture patterns and spatial relationships in the input data samples. Convolution layers may extract features hierarchically, with earlier layers detecting simple patterns and later layers combining these to recognize more complex structures. Feedforward layers, also referred to as fully connected layers, may connect neurons in a layer to neurons in a subsequent layer. Feedforward layers may perform general-purpose computations on input data samples, transforming them through weighted sums and non-linear activations. In some cases, convolution layers may perform feature extraction and feedforward layers may perform final output generation. The parameters of the convolution layers manipulate the data samples more than once, while the feed-forward layers manipulate the input data samples once. In an image classifier machine learning model with convolution layers (e.g., ResNet34), lower (e.g., initial) layers are more sensitive than higher (e.g., later) layers, as the lower layers extract the features from the input images and can influence the machine learning model output. Additionally, or alternatively, parameters in a last layer of a classifier designed using a Prototypical neural network may be more sensitive or important, as the last layer includes the prototypes, or the classification vectors.

Adapting or retraining a subset of parameters (e.g., a fraction or portion of all of the parameters of the machine learning model) of a machine learning model may adapt the functionality of the machine learning model with fewer computational resources and with reduced latency when compared with adapting or retraining an entirety of parameters of the machine learning model. The NE 102-a may determine (e.g., identify, select) the important or sensitive parameters at the end of a training phase of a machine learning model, such as at 208. The NE 102-a may indicate the important or sensitive parameters to the wireless node where the model is deployed (e.g., one or more UEs including the UE 104-a and/or one or more other NEs). For example, the NE 102-a may transmit an indication of the subset of the parameters of the machine learning model 210 to the UE 104-a in signaling. The signaling may include control signaling, such as RRC signaling, DCI, or a MAC-CE, among other examples. In some cases, the NE 102-a may transmit a single message or same signaling including the indication of the parameters of the machine learning models 206 and the indication of the subset of parameters of the machine learning models 210. For example, the indication of the parameters of the machine learning models 206 may include one or more bits or flags that indicate to the UE 104-a which parameters of the machine learning model are the sensitive parameters. In some other cases, the NE 102-a may transmit different messages or different signaling including the indication of the parameters of the machine learning models 206 and the indication of the subset of parameters of the machine learning models 210.

In some examples, a network node may train a machine learning model (e.g., a DNN). In some other examples, a third party device or service may train the machine learning model, and the trained model is transferred to a wireless node or device (e.g., a network node or a node at the edge) for deployment or implementation. The sensitive or important parameters of a machine learning model can be determined at the end of the model training or development phase (e.g., immediately after determining the optimal parameters) by analyzing how sensitive a loss function is with respect to each parameter of the machine learning model. As the network node that trains the machine learning model has access to ground truth values (e.g., the desired output of the machine learning model) for each input data sample, the network node may calculate a sensitivity value or the importance of a parameter by determining a change in the values of the loss function with respect to each parameter of the machine learning model. Once the network node responsible for training the machine learning model determines the important or sensitive parameters of the machine learning model, then the network node may indicate the important or sensitive parameters to one or more other devices (e.g., devices implementing or deploying the machine learning model for making inferences). The network node may also indicate (e.g., transmit, signal, output, transfer) the developed machine learning to the other devices. For example, the NE 102-a may train one or more machine learning models and may transmit the indication of the subset of parameters (e.g., sensitive parameters) of the machine learning models 210 and/or the indication of the parameters of the machine learning models 206 to the UE 104-a and to one or more other devices (e.g., additional UEs or NEs).

In some cases, the network node, wireless node, or device hosting the machine learning models (e.g., the device implementing the machine learning models, the UE 104-a and/or the NE 102-a) may adapt or retrain the machine learning models by updating the important or sensitive parameters of the machine learning models indicated by the subset of parameters and not updating (e.g., refraining from updating) the other parameters of the machine learning models that are not in the subset of parameters that are important or sensitive parameters. For example, at 212, the UE 104-a may update respective parameters of a subset of parameters to update one or more machine learning models. The subset of parameters may include the sensitive parameters indicated in the indication of the subset of parameters of the machine learning models 210. Updating the parameters may include replacing values of the parameters with new values according to training data samples (e.g., using a supervised learning approach, a semi-supervised learning approach, or an unsupervised learning approach).

In some examples, the NE 102-a or the UE 104-a may determine the sensitive parameters of the machine learning model after the machine learning model has been trained. For example, the NE 102-a and/or the UE 104-a may receive a pre-trained machine learning model, and therefore may not have access to labeled training data samples. Thus, the NE 102-a and/or the UE 104-a may be unable to determine the sensitive parameters of the machine learning model during a training process, as the NE 102-a and/or the UE 104-a are not the devices performing the training. Instead, the NE 102-a and/or the UE 104-a may determine the subset of parameters that are the sensitive parameters using unlabeled data samples. For example, the NE 102-a and/or the UE 104-a may determine one or more sensitive or important parameters of a machine learning model by computing a gradient of the input-output mapping function learned by the machine learning model (e.g., a DNN) during training using unlabeled data samples.

In some cases, one or more edge nodes or devices in the wireless communications system 200 (e.g., one or more UEs, including the UE 104-a) may be resource constrained nodes or devices, as they use battery power and may be unable to perform complex computational tasks (e.g., training a machine learning model). To equip the edge nodes or devices with machine learning models, a device and/or a third party with greater computational and/or energy resources may develop the machine learning models. For example, a network node (e.g., the NE 102-a, a gNB), a laboratory of a device vendor, or a third party may develop or train the machine learning models and may send the trained machine learning model to one or more devices in the wireless communications system 200 (e.g., the edge nodes or devices, including the UE 104-a). The UEs or the edge devices or nodes that employ the machine learning model for inference may adapt the machine learning model (e.g., when the statistical characteristics of the input data or environment changes). For the UEs or the edge devices or nodes to adapt a machine learning model in a computationally efficient manner, the devices or nodes hosting the machine learning model may determine one or more important or sensitive parameters of the machine learning model.

However, in some cases, the device that develops the machine learning model may not determine (e.g., find) the important or sensitive parameters of the machine learning model. Additionally, or alternatively, the device that develops the machine learning model may be unable to or may not indicate the important or sensitive parameters of the machine learning model to the devices that host the machine learning model. For example, if the device (e.g., entity, node) that develops the machine learning model has reduced communication resources, then the device may prioritize transmitting the machine learning model parameters over the information indicating the sensitive or important parameters. Additionally, or alternatively, if a third party company or vendor develops the machine learning model, then the third party company or vendor may not determine and/or indicate the important or sensitive parameters of the machine learning model. The node or device hosting the machine learning model (e.g., the UE 104-a) may determine the important or sensitive parameters of the machine learning model independent of the device that trains the machine learning model. The device hosting the machine learning model may update the determined important or sensitive parameters of the machine learning model without updating the remaining parameters of the machine learning model to reduce computational complexity and the time to adapt the machine learning model.

In some examples, the UE 104-a and/or the NE 102-a may determine the sensitive or important parameters of the machine learning model and then may adapt the important or sensitive parameters to achieve desired inference performance under the changed conditions. The device or node hosting the machine learning model may adapt the entire machine learning model (e.g., by updating all of the parameters of the machine learning model) if the device or node determines to or is indicated to adapt the entire machine learning model. If a device accesses labeled data samples from the same data domain over which the machine learning model is trained and if the device accesses a loss function used during the training the machine learning model, then the device can determine a quantum of change in the loss value with respect to each of the trained model parameters. The device may determine one or more parameters of the machine learning model that are more important (e.g., influential, have more control of, significant) in changing the loss value. However, the device deploying the machine learning model for inference may be unable to access the loss function and the labeled data samples.

A machine learning model (e.g., a DNN) may be denoted by f_{W}: [symbol] → [symbol] , where

$$W = {\{ {w}_{j} \}}_{j = 1}^{N}$$

or, equivalently, W=[w₁, . . . , w_{N}]^{T} denotes a set or vector of trained parameters of a machine learning model that are learned with source domain data

$${𝒟}_{tr}^{s} = {\{ ( {x}_{i}^{s} , {y}_{i}^{s} ) \}}_{i = 1}^{{N}_{tr}} ∼ {P}_{XY}^{s} .$$

A device may deploy the machine learning model to make inferences based on incoming input data samples (e.g., from a target domain), denoted by xᵢ, i=1, 2, . . . . K. In some examples, f_{W} denotes the learned function of the machine learning model during training that maps input data samples to output data samples. f_{W}(xᵢ) denotes the inference produced by the machine learning model for the input data sample, xᵢ. Ŵ=W+E=[w₁+e₁, . . . , w_{N}+e_{N}]^{T} denotes a parameter vector offset by a value (e.g., corrupted parameter vector, perturbed parameter vector). To measure sensitivity, a device hosting the machine learning model (e.g., a NE 102-a and/or a UE 104-a) may calculate (e.g., determine, obtain) a difference between an output value when the machine learning model uses the original trained parameters, W and the output value when the machine learning model uses the offset parameters, Ŵ. For a given input sample xᵢ, the output value difference is calculated according to Equation 3.

$${‖ {f}_{\hat{W}} ( {x}_{i} ) - {f}_{W} ( {x}_{i} ) ‖}_{p} \approx {‖ {\sum }_{j = 1}^{N} \frac{\partial {f}_{W} ( {x}_{i} )}{\partial {w}_{j}} {e}_{j} ‖}_{p} \qquad ( 3 )$$

The approximation according to Equation 3 is valid if the offset, eⱼ, is relatively small (e.g., less than a threshold value). The approximation implements a first-order Taylor expansion using the original parameters, W, where higher-order terms are negligible. Note that ∥Z∥ₚ denotes p^{th} norm of Z, and Z may be a scalar or a vector. If p=2, then the norm is a Euclidean norm. However, the value of p may vary according to implementation, and the device implementing the machine learning model may select or preconfigure the value of p. Additionally, or alternatively, if Z is a scalar, then the Euclidean norm is equal to an absolute value. The device implementing (e.g., hosting, deploying) the machine learning model may determine the sensitivity or importance of a parameter wⱼ, 1≤j≤N. For example, the device (e.g., the UE 104-a, and the NE 102-a) may offset the parameter wⱼ by adding eⱼ to the parameter, where eⱼ is a small non-zero value for the j-th entry to produce an offset parameter vector Ŵ, where Ŵ=W+E=[w₁, . . . , wⱼ₋₁, wⱼ+eⱼ, wⱼ₊₁, . . . , w_{N}]^{T}. By using the K input samples, xᵢ, i=1, 2, . . . . K, the device may compute a value of βⱼ according to Equation 4.

$${β}_{j} = \frac{1}{K} {\sum }_{i = 1}^{K} \frac{1}{\vert {e}_{j} \vert} {‖ {f}_{\hat{W}} ( {x}_{i} ) - {f}_{W} ( {x}_{i} ) ‖}_{p} \approx \frac{1}{K} {\sum }_{i = 1}^{K} \frac{1}{\vert {e}_{j} \vert} {‖ \frac{\partial {f}_{W} ( {x}_{i} )}{\partial {w}_{j}} ‖}_{p} \qquad ( 4 )$$

βⱼ is a measure (e.g., an indication) of the sensitivity or importance of a parameter wⱼ.

By comparing the sensitivity or importance of each of the parameters of the machine learning model to a threshold value, the device may determine a subset of parameters that includes one or more sensitive (e.g., influential, important) parameters of the machine learning model. That is, a parameter wⱼ, j=1, . . . , N, is an important or sensitive parameter if βⱼ≥T, where T is a threshold value chosen by the UE 104-a or other device hosting the machine learning model. Using offset values to determine sensitive parameters of the machine learning model provides an accurate measure of the sensitivity or the importance of a parameter when the incoming input data samples xᵢ, i=1, 2, . . . m belong to the source domain over which the machine learning model is initially trained. However, the incoming input data samples originate from a target domain that might differ from the source domain. The discrepancy between domains reduces (e.g., limit) the accuracy of the sensitivity measurement.

As the important or the sensitive parameters of a machine learning model influence the inference performance of the machine learning model to adapt the machine learning model, a device may adapt the important parameters of the machine learning model rather than all of the parameters of the machine learning model (e.g., if the target domain and the source domain do not differ significantly in their statistical properties). The device hosting the machine learning model may determine the important or sensitive parameters of the machine learning models without labeled data and without the loss function adopted during training the machine learning model (e.g., with the input data samples). For example, the device may determine the important or sensitive parameters during the inference phase of implementing the trained machine learning model. Additionally, or alternatively, the device may receive the indication of the subset of parameters of the machine learning models 210 and may determine the important or sensitive parameters from a combination of the indication and the input data samples during the inference phase. The device may adapt the machine learning model by updating or retraining the important or sensitive parameters of the machine learning model at the wireless node or the device.

The node or device hosting the machine learning model may determine when to adapt the machine learning model, such as based on monitoring one or more variations in data samples, according to a configuration or explicit indication, or monitoring network or channel conditions and characteristics, among other examples. For example, the NE 102-a may transmit an explicit indication to the UE 104-a to adapt the machine learning model, and at 212, the UE 104-a may update the sensitive parameters of the machine learning model by replacing the values of the sensitive parameters with new, learned values. Additionally, or alternatively, the NE 102-a may transmit a configuration to the UE 104-a (e.g., in control signaling) that indicates one or more trigger conditions for which the UE 104-a is to adapt the machine learning model. The trigger conditions may include, but are not limited to, a threshold change in output quality of the machine learning model, a periodicity for adapting the machine learning model, or one or more changes in network or channel conditions, among other examples. Additionally, or alternatively, the UE 104-a may monitor for one or more changes or variations in data samples to input to the machine learning model and/or changes in network or channel conditions, and may determine to adapt the machine learning model independent of any signaling or configuration from the NE 102-a.

In some cases, if the NE 102-a implements or deploys the machine learning models, then the NE 102-a may adapt the machine learning models by updating the sensitive parameters and not updating remaining parameters of the machine learning model. The NE 102-a may monitor for one or more conditions that trigger the adaptation of the machine learning models in addition to, or as an alternative to, the UE 104-a monitoring for the one or more conditions that trigger the adaptation of the machine learning model. The UE 104-a and/or the NE 102-a selectively updating a portion or subset of the parameters of the machine learning model (e.g., less than a total number or numerical quantity of parameters of the machine learning model) leads to a reduction in latency and computational complexity for adapting the machine learning model to different domains, making a near-real time adaptation to reduce disruption to the functionality of the wireless communications system 200. In some examples, the UE 104-a and/or the NE 102-a may adapt all of the parameters of the machine learning model if after adapting the important/sensitive parameters, the inference performance of the machine learning model fails to satisfy a threshold performance. Additionally, or alternatively, the UE 104-a and/or the NE 102-a may update the parameters of the machine learning model according to any method of training or changing values of the parameters. Adapting the machine learning model may also be referred to as updating the machine learning model (e.g., a DNN).

In some examples, the UE 104-a and the NE 102-a may exchange communications 214 and/or communications 216 (e.g., messages, signaling, transmissions) using one or more machine learning models. For example, the UE 104-a and/or the NE 102-a may exchange signaling related to beam management, CSI, and/or positioning using the machine learning models, as described with reference to FIG. 1. If the UE 104-a and/or the NE 102-a updates the machine learning model, then the UE 104-a and/or the NE 102-a may use the updated machine learning model to perform the communications 214 and/or the communications 216.

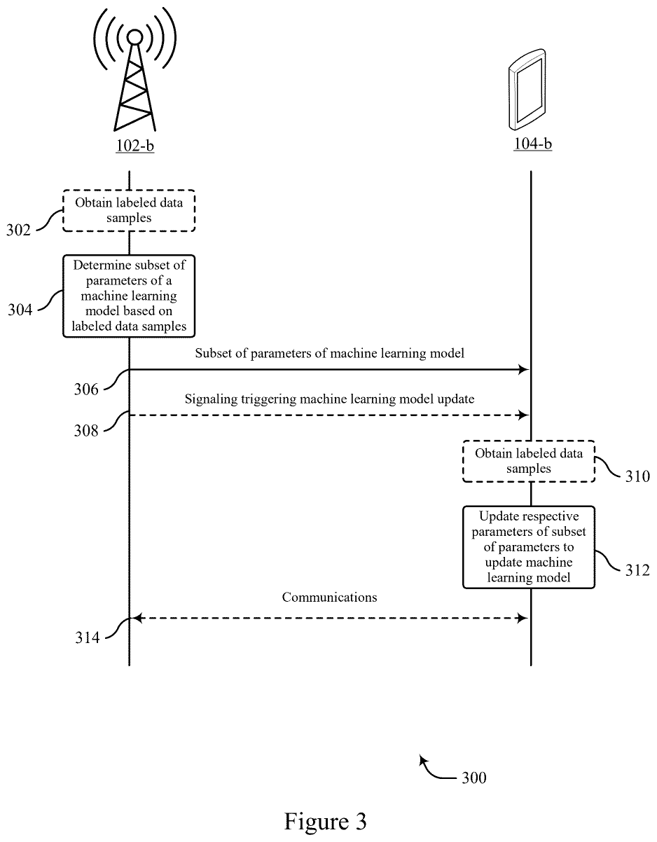

FIG. 3 illustrates an example signaling diagram 300 in accordance with aspects of the present disclosure. In some examples, the signaling diagram 300 may implement aspects of the wireless communications system 100 and the wireless communications system 200. The signaling diagram 300 may illustrate an example of a NE 102-a and a UE 104-a updating one or more machine learning models by updating a subset of parameters (e.g., sensitive parameters) of the machine learning model and refraining from updating a remaining portion of parameters of the machine learning model. The NE 102-a may determine the subset of parameters using labeled data samples and a loss function (e.g., during training of the machine learning model). Alternative examples of the following may be implemented, where some processes are performed in a different order than described or are not performed. In some cases, processes may include additional features not mentioned below, or further processes may be added.

In some examples, at 302, the NE 102-b obtains labeled data samples. The labeled data samples include input data samples and expected output data samples (e.g., a label) for each data samples in the labeled data samples. In some cases, the NE 102-b may receive signaling from another NE or from a third party vendor that indicates a set of data samples. Additionally, or alternatively, the NE 102-b may receive one or more reference signals (e.g., from the UE 104-b, from other UEs, or from other devices in a wireless communications system) and may measure the reference signals to obtain the labeled data samples.

At 304, the NE 102-b determines a subset of parameters of a machine learning model based on the labeled data samples. The subset of parameters may include less than a total number of parameters of the machine learning model and may include sensitive parameters of the machine learning model. For example, the NE 102-b may determine the subset of parameters during training of the machine learning model by determining respective sensitivity values for the parameters of the machine learning model and comparing the respective sensitive values to a threshold value. The respective sensitivity values of the subset of parameters satisfy (e.g., are greater than) a threshold value. In some cases, the NE 102-b may select the threshold value. In some other cases, the threshold value may be preconfigured or otherwise set (e.g., indicated by the UE 104-b or another device).

In some examples, the NE 102-b computes gradient values for respective parameters of the machine learning model using the labeled data samples and a loss function. A gradient value corresponds to a distinct data sample in the set of labeled data samples. The NE 102-b then computes absolute values for the gradient values for the respective parameters. The respective sensitivity values include an average value of the absolute values for the respective parameters.

At 306, the NE 102-b transmits signaling to the UE 104-b that indicates the subset of parameters of the machine learning model. In some cases, the signaling includes the trained parameters of the machine learning model and respective bit values (e.g., flags) that indicate the subset of parameters. For example, the signaling may include values of the parameters obtained from training the machine learning model and a bit for the sensitive parameters that is set to a value (e.g., one or zero), which indicates to the UE 104-b that the parameter is a sensitive parameter. In some other cases, the NE 102-b may transmit signaling to the UE 104-b that indicates indices or other indicators of the sensitive parameters of the parameters of the machine learning model. In some examples, the NE 102-b may transmit same signaling to the UE 104-b that indicates both the subset of parameters and values of the parameters of the machine learning model. In some other examples, the NE 102-b may transmit different signaling to the UE 104-b that indicates the subset of parameters and values of the parameters of the machine learning model. The UE 104-b may receive the indication of the subset of parameters and may update the indicated parameters and may not update the other parameters of the machine learning model when adapting the machine learning model.

At 308, the NE 102-b transmits additional signaling to trigger a machine learning model update. The additional signaling may include control signaling, such as RRC signaling, a MAC-CE, or DCI, that indicates one or more conditions for which the UE 104-b is to update the machine learning model. For example, the additional signaling may indicate a periodicity according to which the UE 104-b is to update the machine learning model, may explicitly instruct the UE 104-b to update the machine learning model, may indicate one or more variations in data samples that trigger the update to the machine learning model, a quality of output from the machine learning model that triggers the update to the machine learning model, variations in channel conditions that trigger the update to the machine learning model, or variations in network conditions that trigger the update to the machine learning model. The variations in data samples may include a threshold numerical quantity of data samples that belong to a different domain than a domain for which the machine learning model is trained. The quality of output from the machine learning model may include a measure of accuracy or precision of the output of the machine learning model, which the NE 102-b and/or the UE 104-b may determine (e.g., monitor, measure). The variations in channel conditions may include changes in signal strength due to fading, multipath propagation effects, interference from other transmitters, or physical obstructions in the signal path. Network conditions may include variations in network load, congestion at one or more devices or nodes in a wireless communications system, or changes to a numerical quantity of active devices in the wireless communications system, among other examples. Environmental factors, such as weather conditions, may also impact both channel and network conditions.

At 310, the UE 104-b obtains one or more labeled data samples. The labeled data samples may include different data samples than the labeled data samples at 302. For example, the labeled data samples at 310 may include data samples that belong to a different domain than the data samples at 302. In some cases, the UE 104-b may receive additional signaling from the NE 102-b including the labeled data samples. Additionally, or alternatively, the UE 104-b may receive additional signaling (e.g., from the NE 102-b or another device) including one or more reference signals. The UE 104-b may obtain the labeled data samples by performing one or more measurements on the one or more reference signals.

At 312, the UE 104-b updates the machine learning model by updating respective parameters of the subset of parameters and refraining from updating a remaining subset of the parameters of the machine learning model. To update the machine learning model, the UE 104-b selects one or more new values for the respective parameters of the subset of parameters using the labeled data samples and a loss function (e.g., a supervised learning approach). The UE 104-b may determine to update the machine learning model based on various factors, including, but not limited to, one or more changes in characteristics (e.g., variations) of the data samples, the periodicity indicated in the additional signaling, one or more changes in network conditions, or a quality associated with output from the machine learning model satisfying a threshold value.

At 314, the UE 104-b and NE 102-b communicate based on the update to the machine learning model. For example, the UE 104-b and/or the NE 102-b may perform beam selection procedures using the updated machine learning model, may perform CSI inference or compression using the updated machine learning model, and/or may perform positioning procedures using the updated machine learning model, among other examples. The communications may include exchange (e.g., output, input, reception, transmission) of signaling between the NE 102-b and the UE 104-b. In some cases, the NE 102-b may also update the machine learning model by updating the subset of parameters (e.g., sensitive parameters) in addition to, or as an alternative to, the UE 104-b updating the machine learning model.

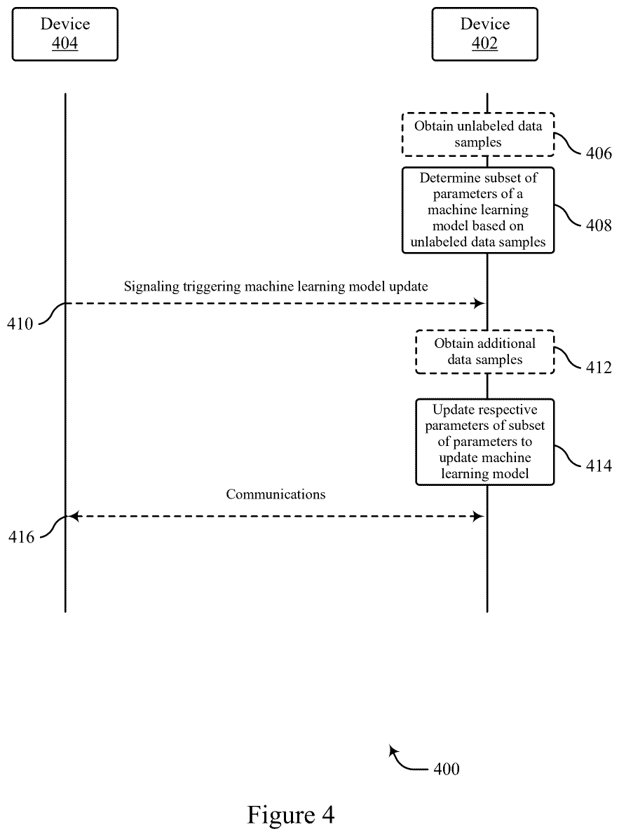

FIG. 4 illustrates an example signaling diagram 400 in accordance with aspects of the present disclosure. In some examples, the signaling diagram 400 may implement aspects of the wireless communications system 100, the wireless communications system 200, and the signaling diagram 300. The signaling diagram 400 may illustrate an example of a device 402 updating one or more machine learning models by updating a subset of parameters (e.g., sensitive parameters) of the machine learning model and refraining from updating a remaining portion of parameters of the machine learning model. The device 402 may determine the subset of parameters using unlabeled data samples and a trained machine learning model. In some cases, the device 402 may be an example of a UE 104 and/or a NE 102 and the device 404 may be an example of a UE 104 and/or a NE 102, as described with reference to FIGS. 1 and 2. Alternative examples of the following may be implemented, where some processes are performed in a different order than described or are not performed. In some cases, processes may include additional features not mentioned below, or further processes may be added.

At 406, the device 402 obtains unlabeled data samples. For example, the device 402 may obtain parameters of a trained machine learning model and unlabeled data samples for input to the machine learning model. In some examples, the device 402 may receive signaling including the unlabeled data samples. Additionally, or alternatively, the device 402 may receive signaling including one or more reference signals and obtain the unlabeled data samples by measuring the reference signals.

At 408, the device 402 determines a subset of parameters (e.g., sensitive parameters) of the machine learning model using the unlabeled data samples. For example, the device 402 may determine respective sensitivity values for respective parameters of the machine learning model according to the unlabeled data samples. The respective sensitivity values of the subset of parameters satisfy a threshold value. To determine the respective sensitivity values, the device 402 may provide the unlabeled data samples as input to the machine learning model to obtain respective first output values. The device 402 may apply an offset value to each parameter of the machine learning model (e.g., to obtain a perturbed set of parameters). The device 402 may provide the unlabeled data samples as input to the machine learning model with offset parameter values to obtain respective second output values. The device 402 may compute a sensitivity value for each parameter by averaging difference values between the respective first output values and the respective second output values. In some cases, the device 402 may determine a norm value of the difference between a second output value and a first output value and may scale the norm with the offset value to determine the difference value. The norm value may include a P-norm value, where P is greater than or equal to unit value. The device 402 may receive signaling that indicates the threshold value (e.g., from the device 404 or from another device) for determining whether the parameter is a sensitive parameter or may determine the threshold value independent of signaling.

At 410, device 404 may transmit signaling to trigger a machine learning model update. For example, the device 404 may be a NE that indicates one or more conditions or configurations that trigger the update to the machine learning model at the device 402 (e.g., a UE or another NE). The signaling may indicate a periodicity for updating the machine learning model, may explicitly instruct the device 402 to update the machine learning model, or may specify conditions for updating the model, such as changes in data characteristics, network conditions, or output quality.

At 412, the device 402 may obtain additional data samples. The data samples may be different data samples than the unlabeled data samples at 406 or may be the same data samples as the data samples at 406. The data samples may include unlabeled data samples or labeled data samples for updating the machine learning model (e.g., according to a supervised learning approach, a semi-supervised approach, or an unsupervised approach). The device 402 may receive the additional data samples in signaling from device 404 or may obtain the additional data samples by measuring one or more reference signals.

At 414, the device 402 updates the machine learning model by updating respective parameters of the subset of parameters and refraining from updating a remaining subset of the machine learning model. For example, the device 402 may select one or more new values for the respective parameters of the subset of parameters using the additional data samples and/or the unlabeled data samples and a loss function. The device 402 may determine to update the machine learning model based on various factors, including, but not limited to, one or more changes in characteristics of the data samples or the additional data samples, the periodicity indicated in the signaling from the device 404, one or more changes in network conditions, a quality of output from the machine learning model satisfying a threshold value, or receiving signaling that indicates for the device 402 to update the machine learning model.

At 416, the device 402 and device 404 communicate based on updating the machine learning model. For example, the device 402 and/or the device 404 may perform beam selection procedures using the updated machine learning model, may perform CSI inference or compression using the updated machine learning model, and/or may perform positioning procedures using the updated machine learning model, among other examples. The communications may include exchange (e.g., output, input, reception, transmission) of signaling between the device 402 and the device 404. In some cases, the device 404 may also update the machine learning model by updating the subset of parameters (e.g., sensitive parameters) in addition to, or as an alternative to, the device 402 updating the machine learning model.

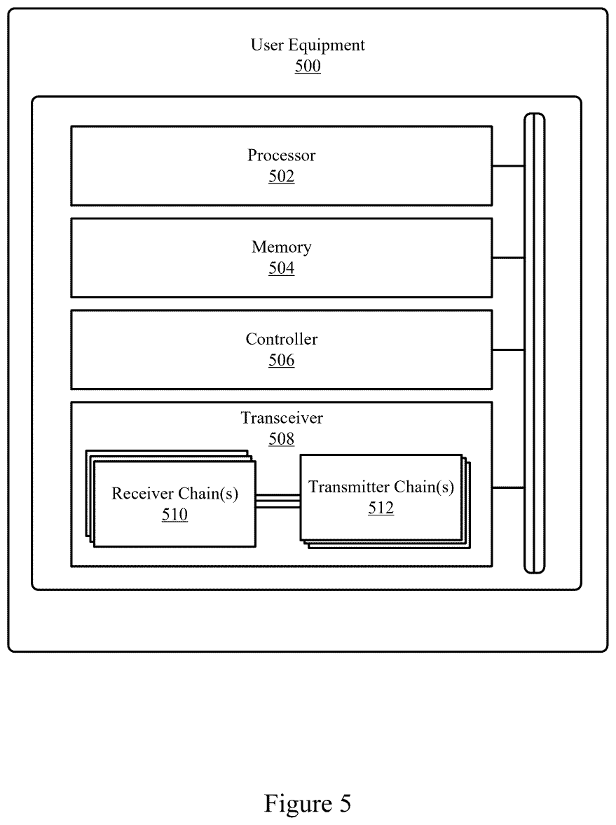

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for receiving signaling that indicates a subset of parameters of a set of parameters associated with a machine learning model, updating the machine learning model by updating respective parameters of the subset of parameters and refraining from updating a remaining subset of the set of parameters associated with the machine learning model, and communicating based on updating the machine learning model.

Additionally, the UE 500 may be configured to support any one or combination of obtaining a set of data samples, where the set of data samples includes a set of input data samples and a set of corresponding expected output data samples, and selecting one or more new values for the respective parameters of the subset of parameters based on the set of data samples and a loss function associated with the subset of parameters of the set of parameters. Additionally, or alternatively, the UE 500 may be configured to support receiving, prior to the communicating, additional signaling including the set of data samples. Additionally, or alternatively, the UE 500 may be configured to support receiving, prior to the communicating, additional signaling including one or more reference signals, and obtaining, based on one or more measurements associated with the one or more reference signals, the set of data samples. Additionally, or alternatively, the UE 500 may be configured to support determining to update the machine learning model based on one or more changes in characteristics of the set of data samples. Additionally, or alternatively, the UE 500 may be configured to support receiving additional signaling that indicates a periodicity associated with updating the machine learning model, and determining to update the machine learning model based on the periodicity.

Additionally, or alternatively, the UE 500 may be configured to support receiving additional signaling that indicates for the UE to update the machine learning model, where one or more of the signaling or the additional signaling are received from a first NE or a second NE, and determining, responsive to the additional signaling, to update the machine learning model. Additionally, or alternatively, the UE 500 may be configured to support determining to update the machine learning model based on one or more changes in network conditions associated with the communicating. Additionally, or alternatively, the UE 500 may be configured to support determining to update the machine learning model based on a quality associated with output from the machine learning model satisfying a threshold value. Additionally, or alternatively, the UE 500 may be configured to support the signaling includes the set of parameters and respective bit values corresponding to the subset of parameters, and where the respective bit values indicate the subset of parameters are associated with updating the machine learning model.

Additionally, or alternatively, the UE 500 may support at least one memory (e.g., the memory 504) and at least one processor (e.g., the processor 502) coupled with the at least one memory and configured to cause the UE to receive signaling that indicates a subset of parameters of a set of parameters associated with a machine learning model, update the machine learning model by updating respective parameters of the subset of parameters and refraining from updating a remaining subset of the set of parameters associated with the machine learning model, and communicate based on updating the machine learning model.

Additionally, the UE 500 may be configured to support any one or combination of to obtain a set of data samples, where the set of data samples includes a set of input data samples and a set of corresponding expected output data samples, and select one or more new values for the respective parameters of the subset of parameters based on the set of data samples and a loss function associated with the subset of parameters of the set of parameters. Additionally, or alternatively, the UE 500 may be configured to support to receive, prior to the communicating, additional signaling including the set of data samples. Additionally, or alternatively, the UE 500 may be configured to support to receive, prior to the communicating, additional signaling including one or more reference signals, and obtain, based on one or more measurements associated with the one or more reference signals, the set of data samples. Additionally, or alternatively, the UE 500 may be configured to support to determine to update the machine learning model based on one or more changes in characteristics of the set of data samples. Additionally, or alternatively, the UE 500 may be configured to support to receive additional signaling that indicates a periodicity associated with updating the machine learning model and determine to update the machine learning model based on the periodicity.

Additionally, or alternatively, the UE 500 may be configured to support to receive additional signaling that indicates for the UE to update the machine learning model, where one or more of the signaling or the additional signaling are received from a first NE or a second NE, and determine, responsive to the additional signaling, to update the machine learning model. Additionally, or alternatively, the UE 500 may be configured to support to determine to update the machine learning model based on one or more changes in network conditions associated with the communicating. Additionally, or alternatively, the UE 500 may be configured to support to determine to update the machine learning model based on a quality associated with output from the machine learning model satisfying a threshold value. Additionally, or alternatively, the UE 500 may be configured to support the signaling includes the set of parameters and respective bit values corresponding to the subset of parameters, and where the respective bit values indicate the subset of parameters are associated with updating the machine learning model.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

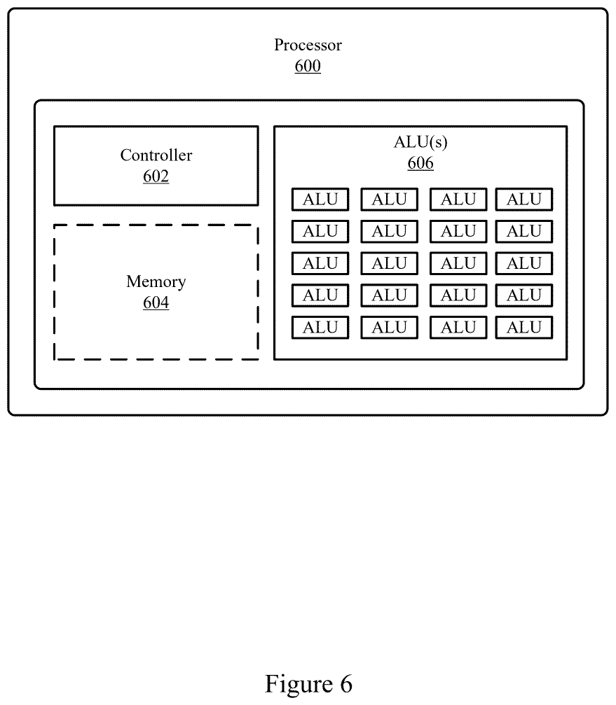

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to receive signaling that indicates a subset of parameters of a set of parameters associated with a machine learning model, update the machine learning model by updating respective parameters of the subset of parameters and refraining from updating a remaining subset of the set of parameters associated with the machine learning model, and communicate based on updating the machine learning model.

Additionally, the processor 600 may be configured to or operable to support any one or combination of to obtain a set of data samples, where the set of data samples includes a set of input data samples and a set of corresponding expected output data samples, and select one or more new values for the respective parameters of the subset of parameters based on the set of data samples and a loss function associated with the subset of parameters of the set of parameters. Additionally, or alternatively, the processor 600 may be configured to support to receive, prior to the communicating, additional signaling including the set of data samples. Additionally, or alternatively, the processor 600 may be configured to support to receive, prior to the communicating, additional signaling including one or more reference signals, and obtain, based on one or more measurements associated with the one or more reference signals, the set of data samples. Additionally, or alternatively, the processor 600 may be configured to support to determine to update the machine learning model based on one or more changes in characteristics of the set of data samples. Additionally, or alternatively, the processor 600 may be configured to support to receive additional signaling that indicates a periodicity associated with updating the machine learning model and determine to update the machine learning model based on the periodicity.

Additionally, or alternatively, the processor 600 may be configured to support to receive additional signaling that indicates for the processor to update the machine learning model, where one or more of the signaling or the additional signaling are received from a first NE or a second NE, and determine, responsive to the additional signaling, to update the machine learning model. Additionally, or alternatively, the processor 600 may be configured to support to determine to update the machine learning model based on one or more changes in network conditions associated with the communicating. Additionally, or alternatively, the processor 600 may be configured to support to determine to update the machine learning model based on a quality associated with output from the machine learning model satisfying a threshold value. Additionally, or alternatively, the processor 600 may be configured to support the signaling includes the set of parameters and respective bit values corresponding to the subset of parameters, and where the respective bit values indicate the subset of parameters are associated with updating the machine learning model.

The processor 600 may be configured to or operable to support at least one controller (e.g., the controller 602) coupled with at least one memory (e.g., the memory 604) and configured to cause the processor to determine a subset of parameters of a set of parameters associated with a machine learning model based on a set of data samples, where the set of data samples includes a set of input data samples and a set of corresponding expected output data samples, transmit signaling that indicates the subset of parameters of the set of parameters, where the subset of parameters is associated with an update to the machine learning model, and communicate based on the update to the machine learning model.

Additionally, the processor 600 may be configured to or operable to support any one or combination of to receive, prior to the signaling, additional signaling including the set of data samples. Additionally, or alternatively, the processor 600 may be configured to support to receive, prior to the signaling, additional signaling including one or more reference signals, and obtain, based on one or more measurements associated with the one or more reference signals, the set of data samples. Additionally, or alternatively, the processor 600 may be configured to support the signaling includes the set of parameters and respective bit values corresponding to the subset of parameters, and where the respective bit values indicate the subset of parameters are associated with the update to the machine learning model. Additionally, or alternatively, the processor 600 may be configured to support to determine the subset of parameters, determine, during training of the machine learning model based on the set of data samples, respective sensitivity values corresponding to the set of parameters, and where the respective sensitivity values of the subset of parameters satisfy a threshold value. Additionally, or alternatively, the processor 600 may be configured to support to determine the respective sensitivity values corresponding to the set of parameters, compute, for respective parameters of the set of parameters, a set of gradient values corresponding to respective data samples of the set of data samples, and compute, for the respective parameters of the set of parameters, a set of absolute values for respective gradient values of the set of gradient values, where the respective sensitivity values include an average value of the set of absolute values for the respective parameters of the set of parameters.

Additionally, or alternatively, the processor 600 may be configured to support to transmit, prior to the communicating, additional signaling including an additional set of data samples. Additionally, or alternatively, the processor 600 may be configured to support transmit, prior to the communicating, additional signaling including one or more reference signals, where the one or more reference signals are associated with an additional set of data samples. Additionally, or alternatively, the processor 600 may be configured to support to transmit additional signaling that indicates a periodicity associated with the update to the machine learning model. Additionally, or alternatively, the processor 600 may be configured to support to transmit additional signaling that indicates for a UE to update the machine learning model.

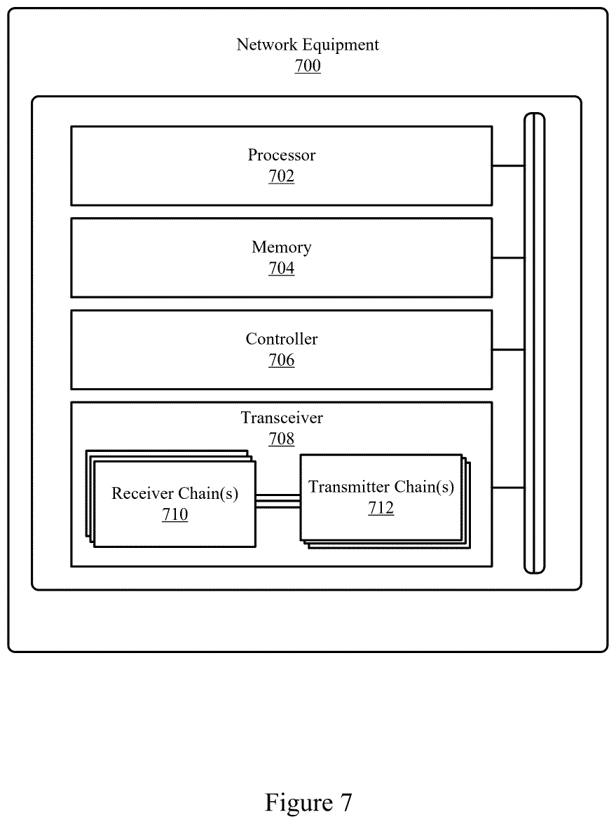

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for determining a subset of parameters of a set of parameters associated with a machine learning model based on a set of data samples, where the set of data samples includes a set of input data samples and a set of corresponding expected output data samples, transmitting signaling that indicates the subset of parameters of the set of parameters, where the subset of parameters is associated with an update to the machine learning model, and communicating based on the update to the machine learning model.

Additionally, the NE 700 may be configured to or operable to support any one or combination of receiving, prior to the signaling, additional signaling including the set of data samples. Additionally, or alternatively, the NE 700 may be configured to support receiving, prior to the signaling, additional signaling including one or more reference signals, and obtaining, based on one or more measurements associated with the one or more reference signals, the set of data samples. Additionally, or alternatively, the NE 700 may be configured to support the signaling includes the set of parameters and respective bit values corresponding to the subset of parameters, and where the respective bit values indicate the subset of parameters are associated with the update to the machine learning model. Additionally, or alternatively, the NE 700 may be configured to support to determine the subset of parameters, determining, during training of the machine learning model based on the set of data samples, respective sensitivity values corresponding to the set of parameters, and where the respective sensitivity values of the subset of parameters satisfy a threshold value. Additionally, or alternatively, the NE 700 may be configured to support to determine the respective sensitivity values corresponding to the set of parameters, computing, for respective parameters of the set of parameters, a set of gradient values corresponding to respective data samples of the set of data samples, and computing, for the respective parameters of the set of parameters, a set of absolute values for respective gradient values of the set of gradient values, where the respective sensitivity values include an average value of the set of absolute values for the respective parameters of the set of parameters.

Additionally, or alternatively, the NE 700 may be configured to support transmitting, prior to the communicating, additional signaling including an additional set of data samples. Additionally, or alternatively, the NE 700 may be configured to support transmitting, prior to the communicating, additional signaling including one or more reference signals, where the one or more reference signals are associated with an additional set of data samples. Additionally, or alternatively, the NE 700 may be configured to support transmitting additional signaling that indicates a periodicity associated with the update to the machine learning model. Additionally, or alternatively, the NE 700 may be configured to support transmitting additional signaling that indicates for a UE to update the machine learning model.

Additionally, or alternatively, the NE 700 may support at least one memory (e.g., the memory 704) and at least one processor (e.g., the processor 702) coupled with the at least one memory and configured to cause the NE to determine a subset of parameters of a set of parameters associated with a machine learning model based on a set of data samples, where the set of data samples includes a set of input data samples and a set of corresponding expected output data samples, transmit signaling that indicates the subset of parameters of the set of parameters, where the subset of parameters is associated with an update to the machine learning model, and communicate based on the update to the machine learning model.

Additionally, the NE 700 may be configured to support any one or combination of to receive, prior to the signaling, additional signaling including the set of data samples. Additionally, or alternatively, the NE 700 may be configured to support to receive, prior to the signaling, additional signaling including one or more reference signals, and obtain, based on one or more measurements associated with the one or more reference signals, the set of data samples. Additionally, or alternatively, the NE 700 may be configured to support the signaling includes the set of parameters and respective bit values corresponding to the subset of parameters, and where the respective bit values indicate the subset of parameters are associated with the update to the machine learning model. Additionally, or alternatively, the NE 700 may be configured to support to determine the subset of parameters, determine, during training of the machine learning model based on the set of data samples, respective sensitivity values corresponding to the set of parameters, and where the respective sensitivity values of the subset of parameters satisfy a threshold value. Additionally, or alternatively, the NE 700 may be configured to support to determine the respective sensitivity values corresponding to the set of parameters, compute, for respective parameters of the set of parameters, a set of gradient values corresponding to respective data samples of the set of data samples, and compute, for the respective parameters of the set of parameters, a set of absolute values for respective gradient values of the set of gradient values, where the respective sensitivity values include an average value of the set of absolute values for the respective parameters of the set of parameters.

Additionally, or alternatively, the NE 700 may be configured to support to transmit, prior to the communicating, additional signaling including an additional set of data samples. Additionally, or alternatively, the NE 700 may be configured to support to transmit, prior to the communicating, additional signaling including one or more reference signals, where the one or more reference signals are associated with an additional set of data samples. Additionally, or alternatively, the NE 700 may be configured to support to transmit additional signaling that indicates a periodicity associated with the update to the machine learning model. Additionally, or alternatively, the NE 700 may be configured to support to transmit additional signaling that indicates for a UE to update the machine learning model.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

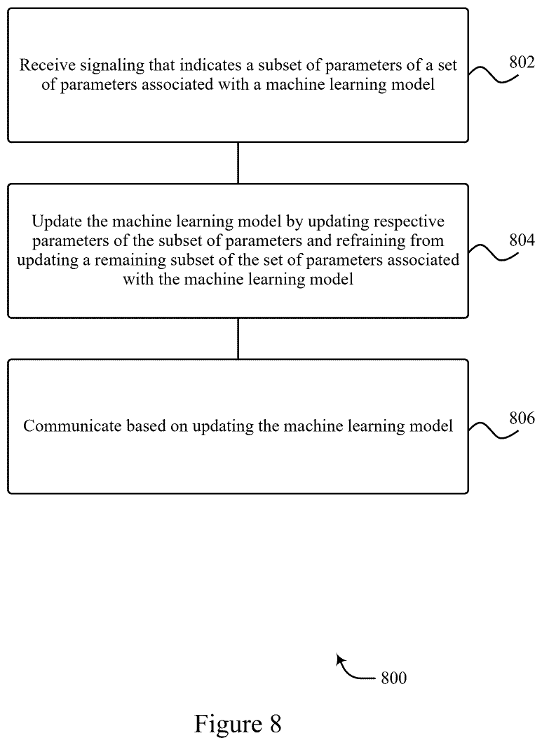

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include receiving signaling that indicates a subset of parameters of a set of parameters associated with a machine learning model. The operations of 802 may be performed in accordance with examples as described herein. In some implementations, aspects of the operations of 802 may be performed by a UE as described with reference to FIG. 5.

At 804, the method may include updating the machine learning model by updating respective parameters of the subset of parameters and refraining from updating a remaining subset of the set of parameters associated with the machine learning model. The operations of 804 may be performed in accordance with examples as described herein. In some implementations, aspects of the operations of 804 may be performed by a UE as described with reference to FIG. 5.

At 806, the method may include communicating based on updating the machine learning model. The operations of 806 may be performed in accordance with examples as described herein. In some implementations, aspects of the operations of 806 may be performed a UE as described with reference to FIG. 5.

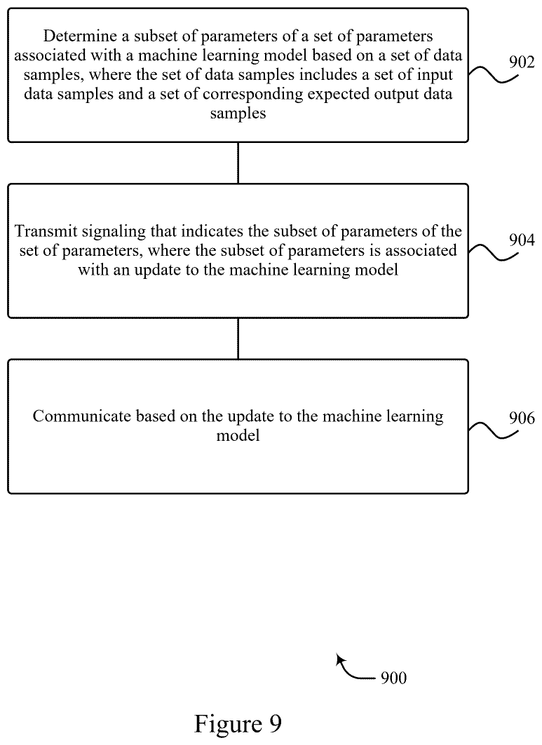

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include determining a subset of parameters of a set of parameters associated with a machine learning model based on a set of data samples, where the set of data samples includes a set of input data samples and a set of corresponding expected output data samples. The operations of 902 may be performed in accordance with examples as described herein. In some implementations, aspects of the operations of 902 may be performed by an NE as described with reference to FIG. 7.

At 904, the method may include transmitting signaling that indicates the subset of parameters of the set of parameters, where the subset of parameters is associated with an update to the machine learning model. The operations of 904 may be performed in accordance with examples as described herein. In some implementations, aspects of the operations of 904 may be performed by an NE as described with reference to FIG. 7.

At 906, the method may include communicating based on the update to the machine learning model. The operations of 906 may be performed in accordance with examples as described herein. In some implementations, aspects of the operations of 906 may be performed an NE as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive signaling that indicates a subset of parameters of a plurality of parameters associated with a machine learning model;
update the machine learning model by updating respective parameters of the subset of parameters and refraining from updating a remaining subset of the plurality of parameters associated with the machine learning model; and
communicate based at least in part on updating the machine learning model.

2. The UE of claim 1, wherein to update the machine learning model, the at least one processor is operable to cause the UE to:
obtain a plurality of data samples, wherein the plurality of data samples comprises a plurality of input data samples and a plurality of corresponding expected output data samples; and
select one or more new values for the respective parameters of the subset of parameters based at least in part on the plurality of data samples and a loss function associated with the subset of parameters of the plurality of parameters.

3. The UE of claim 2, wherein to obtain the plurality of data samples, the at least one processor is operable to cause the UE to receive, prior to the communicating, additional signaling comprising the plurality of data samples.

4. The UE of claim 2, wherein to obtain the plurality of data samples, the at least one processor is further operable to cause the UE to:
receive, prior to the communicating, additional signaling comprising one or more reference signals; and
obtain, based at least in part on one or more measurements associated with the one or more reference signals, the plurality of data samples.

5. The UE of claim 2, wherein the at least one processor is further operable to cause the UE to determine to update the machine learning model based at least in part on one or more changes in characteristics of the plurality of data samples.

6. The UE of claim 1, wherein the at least one processor is further operable to cause the UE to:
receive additional signaling that indicates a periodicity associated with updating the machine learning model; and
determine to update the machine learning model based at least in part on the periodicity.

7. The UE of claim 1, wherein the at least one processor is further operable to cause the UE to:
receive additional signaling that indicates for the UE to update the machine learning model, wherein one or more of the signaling or the additional signaling are received from a first network equipment (NE) or a second NE; and
determine, responsive to the additional signaling, to update the machine learning model.

8. The UE of claim 1, wherein the at least one processor is further operable to cause the UE to determine to update the machine learning model based at least in part on one or more changes in network conditions associated with the communicating.

9. The UE of claim 1, wherein the at least one processor is further operable to cause the UE to determine to update the machine learning model based at least in part on a quality associated with output from the machine learning model satisfying a threshold value.

10. The UE of claim 1, wherein the signaling comprises the plurality of parameters and respective bit values corresponding to the subset of parameters, and wherein the respective bit values indicate the subset of parameters are associated with updating the machine learning model.

11. A processor for wireless communication, comprising:
at least one controller coupled with at least one memory and operable to cause the processor to:
receive signaling that indicates a subset of parameters of a plurality of parameters associated with a machine learning model;
update the machine learning model by updating respective parameters of the subset of parameters and refraining from updating a remaining subset of the plurality of parameters associated with the machine learning model; and
communicate based at least in part on updating the machine learning model.

12. The processor of claim 11, wherein to update the machine learning model, the at least one controller is operable to cause the processor to:
obtain a plurality of data samples, wherein the plurality of data samples comprises a plurality of input data samples and a plurality of corresponding expected output data samples; and
select one or more new values for the respective parameters of the subset of parameters based at least in part on the plurality of data samples and a loss function associated with the subset of parameters of the plurality of parameters.

13. The processor of claim 11, wherein the at least one controller is further operable to cause the processor to:
receive additional signaling that indicates a periodicity associated with updating the machine learning model; and
determine to update the machine learning model based at least in part on the periodicity.

14. The processor of claim 11, wherein the at least one controller is further operable to cause the processor to:
receive additional signaling that indicates for the processor to update the machine learning model, wherein one or more of the signaling or the additional signaling are received from a first network equipment (NE) or a second NE; and
determine, responsive to the additional signaling, to update the machine learning model.

15. A method performed by a user equipment (UE), the method comprising:
receiving signaling that indicates a subset of parameters of a plurality of parameters associated with a machine learning model;
updating the machine learning model by updating respective parameters of the subset of parameters and refraining from updating a remaining subset of the plurality of parameters associated with the machine learning model; and
communicating based at least in part on updating the machine learning model.

16. A network equipment (NE) for wireless communication, comprising:
at least one memory; and
at least one processor coupled with the at least one memory and operable to cause the NE to:
determine a subset of parameters of a plurality of parameters associated with a machine learning model based at least in part on a plurality of data samples, wherein the plurality of data samples comprises a plurality of input data samples and a plurality of corresponding expected output data samples;
transmit signaling that indicates the subset of parameters of the plurality of parameters, wherein the subset of parameters is associated with an update to the machine learning model; and
communicate based at least in part on the update to the machine learning model.

17. The NE of claim 16, wherein the at least one processor is further operable to cause the NE to receive, prior to the signaling, additional signaling comprising the plurality of data samples.

18. The NE of claim 16, wherein the at least one processor is further operable to cause the NE to:
receive, prior to the signaling, additional signaling comprising one or more reference signals; and
obtain, based at least in part on one or more measurements associated with the one or more reference signals, the plurality of data samples.

19. The NE of claim 16, wherein to determine the subset of parameters, the at least one processor is operable to cause the NE to determine, during training of the machine learning model based at least in part on the plurality of data samples, respective sensitivity values corresponding to the plurality of parameters, and wherein the respective sensitivity values of the subset of parameters satisfy a threshold value.

20. The NE of claim 19, wherein to determine the respective sensitivity values corresponding to the plurality of parameters, the at least one processor is operable to cause the NE to:
compute, for respective parameters of the plurality of parameters, a plurality of gradient values corresponding to respective data samples of the plurality of data samples; and
compute, for the respective parameters of the plurality of parameters, a plurality of absolute values for respective gradient values of the plurality of gradient values, wherein the respective sensitivity values comprise an average value of the plurality of absolute values for the respective parameters of the plurality of parameters.
